(19) United States
(12) Patent Application Publication
(10) Pub. No.: US 2022/0126935 A1
(43) Pub. Date: Apr. 28, 2022

(54) MODULAR TRAILER

(71) Applicant: Carry-On Trailer, Inc., Lavonia, GA (US)

(72) Inventors: Samuel YODER, High Point, NC (US); Jeff HULTQUIST, Cameron, IL (US); Jordan KIMBROUGH, Peoria, IL (US); Paul SMITH, Lavonia, GA (US)

(21) Appl. No.: 17/512,352

(22) Filed: Oct. 27, 2021

Related U.S. Application Data
(60) Provisional application No. 63/106,679, filed on Oct. 28, 2020.

(51) Int. Cl. B62D 63/06; B62D 27/02; B62D 65/02

(52) U.S. Cl. CPC B62D 63/064; B62D 65/024; B62D 27/023

(57) ABSTRACT

A modular trailer comprising a base frame and a side-rail assembly configured to be secured to the base frame. The side-rail assembly comprises an elongated side rail and a plurality of uprights extending from the side rail. The modular trailer further comprises a plurality of connection assemblies configured to secure the side-rail assembly to the base frame. Each connection assembly comprises an outer connection plate rigidly secured to an associated upright of the plurality of uprights and one or more fasteners configured to extend through the base frame and into engagement with the outer connection plate.

### CROSS-REFERENCE TO RELATED APPLICATION

The present non-provisional patent application claims priority benefit to U.S. Provisional Patent Application Ser. No. 63/106,679, filed on Oct. 28, 2020, and entitled “MODULAR TRAILER.” The above-identified provisional patent application is hereby incorporated by reference, in its entirety, into the present non-provisional patent application.

### FIELD

Embodiments of the present invention are generally directed to trailers. More particularly, embodiments of the present invention are directed to trailers with modular components that can be efficiently transported and assembled.

### RELATED ART

Trailers are commonly used in conjunction with vehicles to transport loads. Efficient shipping of trailers is a high priority for trailer manufacturers, as shipping costs can be a significant expense. Often, after manufacture, trailers will be shipped on semi-haulers to their intended destinations. The more trailers that can fit on a given semi-hauler for transport will reduce the overall expense for the manufacturer.

### SUMMARY

To address the above-described challenges, embodiments of the present invention provide a modular trailer comprising a plurality of components that can be efficiently shipped in an unassembled configuration. Once the modular trailer has reached its intended destination, the components of the modular trailer are configured to be efficiently assembled to form an aesthetic, structurally-sound trailer.

In more detail, embodiments of the present invention include a modular trailer comprising a base frame and a side-rail assembly configured to be secured to the base frame. The side-rail assembly comprises an elongated side rail and a plurality of uprights extending from the side rail. The modular trailer further comprises a plurality of connection assemblies configured to secure the side-rail assembly to the base frame. Each connection assembly comprises an outer connection plate rigidly secured to an associated upright of the plurality of uprights and one or more fasteners configured to extend through the base frame and into engagement with the outer connection plate.

Embodiments of the present invention additionally include a modular trailer comprising a base frame and a side-rail assembly configured to be secured to the base frame. The side-rail assembly comprises an elongated side rail and a plurality of uprights extending from the side rail. The modular trailer further comprises a connection assembly associated with each upright and configured to secure the side-rail assembly to the base frame. When viewing the trailer from a lateral side, the connection assemblies are not visible.

Embodiments of the present invention further include a method of assembling a modular trailer. The method comprises a step of providing the modular trailer comprising a base frame and a side-rail assembly configured to be secured to the base frame. The side-rail assembly comprises an elongated side rail and a plurality of uprights extending from the side rail. An additional step includes coupling each upright to the base frame via a connection assembly. Each connection assembly comprises an outer connection plate rigidly secured to one of the uprights and one or more fasteners configured to extend through the base frame and into engagement with the outer connection plate. When viewing the modular trailer from a lateral side, the connection assemblies are not visible.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a front perspective view of a modular trailer according to embodiments of the present invention;

FIG. 2 is a rear perspective view of the modular trailer from FIG. 1,

FIG. 3 is an exploded view of the modular trailer from FIGS. 1 and 2;

FIG. 4 is a partial exploded view of a left side portion of the modular trailer from FIGS. 1-3;

FIG. 5 is perspective view of a connection assembly being used to secure an upright of a side-rail assembly to a base frame of the modular trailer from FIGS. 1-4, with a portion of the base frame cut away to better illustrate the connection assembly;

FIG. 6 is an exploded view of the upright and the connection assembly from FIG. 5;

FIG. 7 is a perspective view of the connection assembly from FIGS. 5 and 6;

FIG. 8 is a bottom perspective view of the upright and the connection assembly from FIGS. 5 and 6, with a portion of the upright cut away to better illustrate the connection assembly;

FIG. 9 is a perspective view of the upright and a portion of the connection assembly from FIGS. 5, 6, and 8;

FIG. 10 is a bottom elevation view of a side rail assembly being secured to a base frame of a modular trailer according to embodiments of the present invention; and

FIG. 11 is a side elevation view of the side-rail assembly being secured to a base frame of the modular trailer from FIG. 10.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

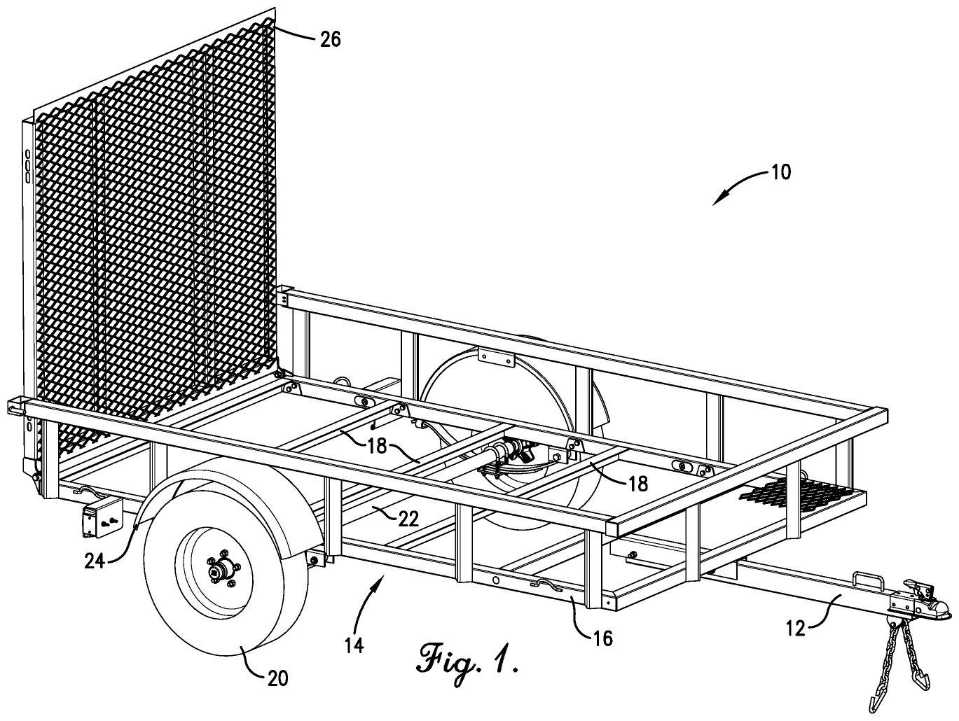

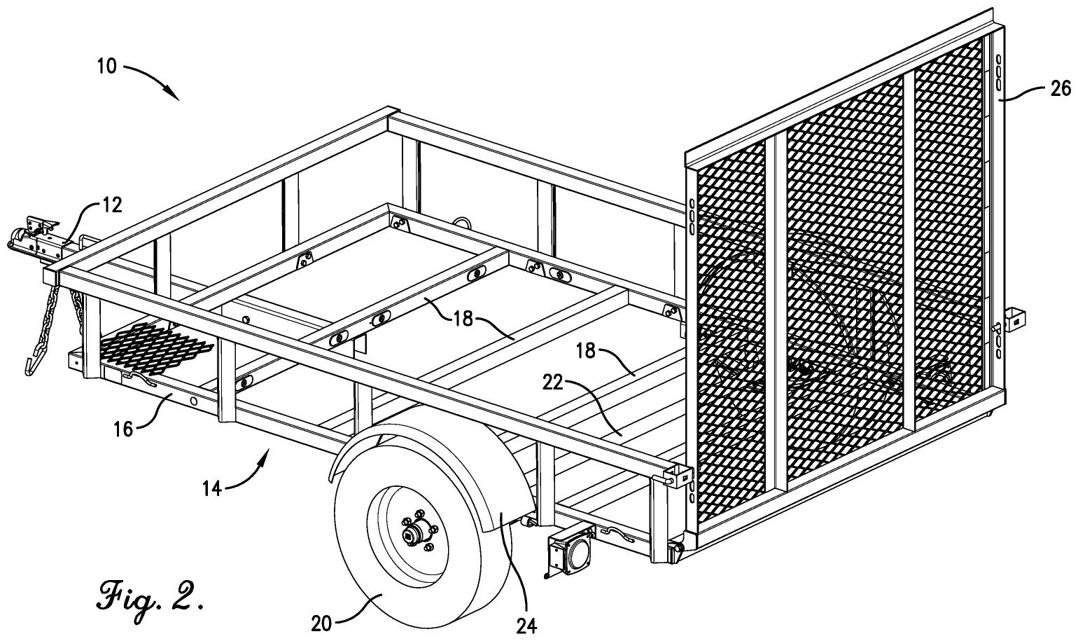

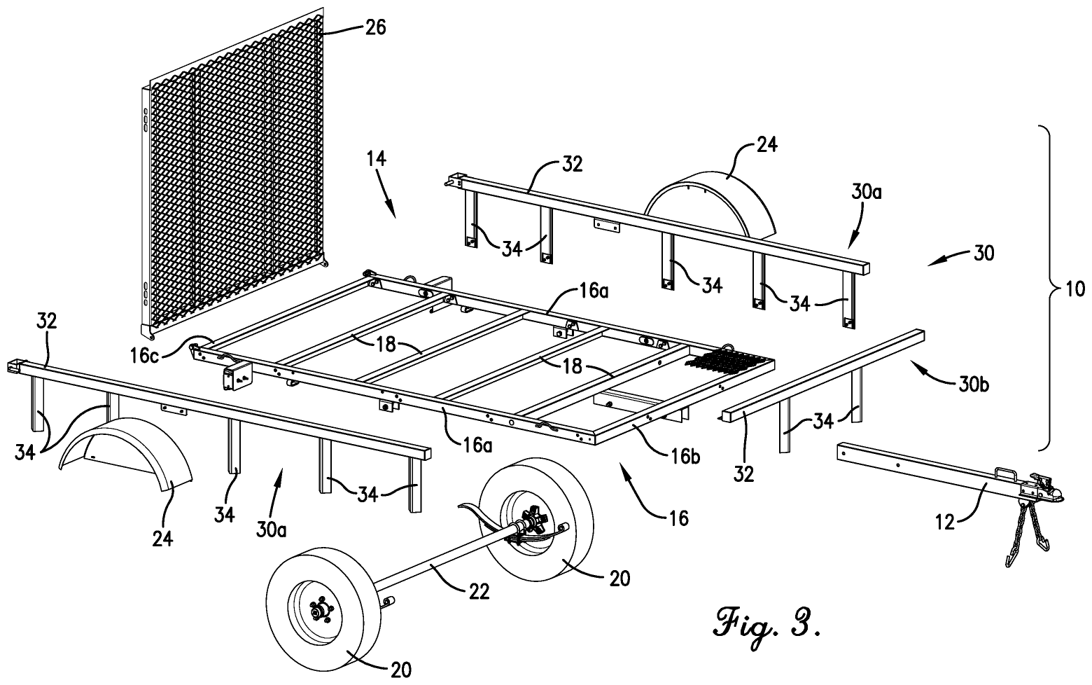

With reference to the figures, and particularly to FIGS. 1 and 2, embodiments of the present invention are broadly directed to a modular, utility trailer 10 (referred to herein as the “trailer”), configured to be hitched to the rear of a motor vehicle (not shown) via a towbar 12. Referring FIGS. 1-3, the trailer 10 may comprise a main section 14, which may form a bed or deck for supporting cargo. The main section 14 may include base frame 16 extending around a perimeter of the main section 14. In some embodiment, the base frame 16 will be generally rectangular, comprising a pair of side frame elements 16a, a front frame element 16b, and a rear frame element 16c (see FIG. 3). Such frame elements 16a, b, c, may be formed from square, steel tubing and interconnected via welding, fasteners, or the like.

Remaining with FIG. 1-3, the main section 14 may also comprise one or more support elements 18 extending laterally and/or longitudinally across an interior space defined by the base frame 16. Such support elements 18 may be formed from L-shaped, steel tubing and interconnected with the base frame 16 via welding, fasteners, or the like. In some embodiments, a platform (e.g., formed from wood paneling) may be positioned on and/or supported by the base frame 16 and/or the support elements 18, so as to present a bed/deck for supporting cargo. As such, the main section 14 may define a cargo area on which cargo can be supported.

The trailer 10 may be supported on the ground by a pair of wheels 20 connected via a single axle 22. The axle 22 may be attached to the main section 14 via a suspension system (e.g., a spring-type suspension system). Each wheel 20 may be provided with a protective wheel cover 24 that is also connected to the main section 14 (and/or to a side-rail assembly discussed in more detail below). In alternative embodiments, the trailer 10 may be configured as a multi-axle trailer.

The towbar 12 extends forward from the main section 14 and is configured to be attached to a vehicle for pulling the trailer 10. A rotatable ramp 26 may be rotatably secured to a back end of the trailer 10 (e.g., to the rear frame element 16c). In a lowered position, the ramp 26 may facilitate loading and unloading of cargo to/from the trailer 10. In a raised position, the ramp 26 may act as a tailgate to keep the load secured on the trailer 10. In some embodiment, the ramp 26 may be used in place of a rear frame element 16c of the base frame 16.

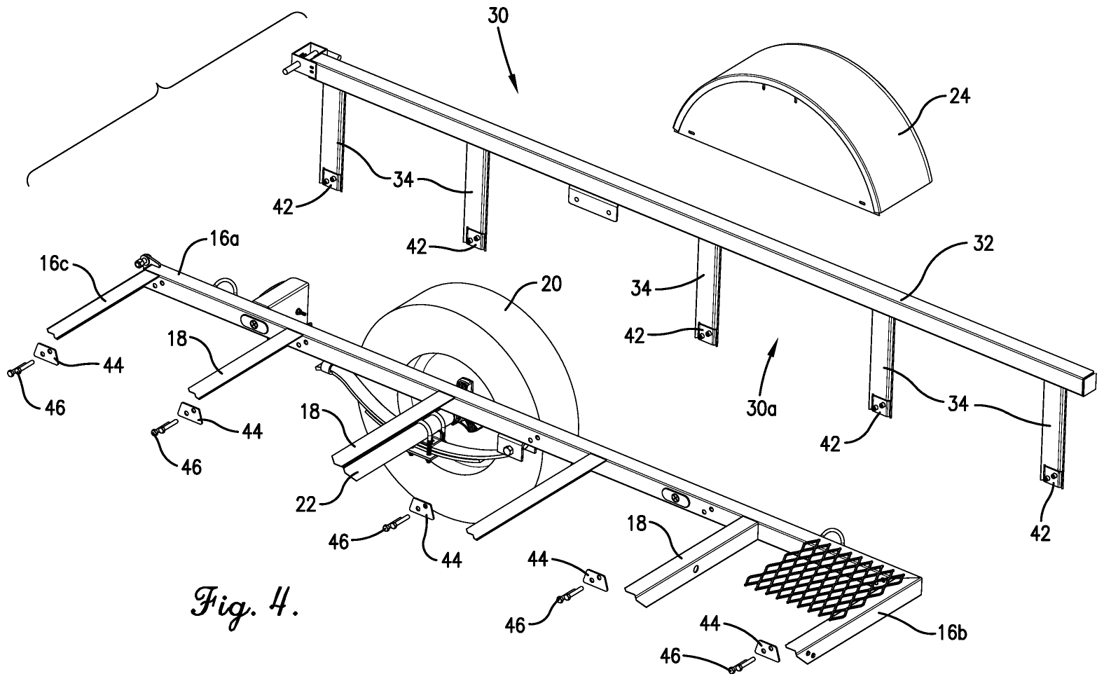

Finally, as illustrated in FIGS. 3 and 4, the trailer 10 may include a side-rail assembly 30 that extends at least partially around the perimeter of the cargo area of the trailer 10. In some embodiments, the side-rail assembly 30 will be secured to and include portions that extend upward from one or more of the frame elements 16a, 16b, 16c of the base frame 16. As such, the side-rail assembly 30 may comprise a pair of side portions 30a, a front portion 30b, and a rear portion. In embodiments that include the ramp 26, as shown in the figures, the side-rail assembly 30 may not include a rear portion, such that the side-rail assembly 30 may only include pair of side portions 30a and a front portion 30b, as illustrated in FIG. 3, which are respectively secured to and/or extend upward from the side frame elements 16a and the front frame element 16b of the base frame 16.

In more detail, the side-rail assembly 30 can be secured to the base frame 16 of the main section 14 via one or more connection assemblies (described in more detail below). The connection assemblies are configured to permit the side-rail assembly 30 and the main section 14 to be shipped in an unassembled configuration, and to be efficiently assembled to form an aesthetic, structurally-sound trailer 10. With reference to FIG. 4, each portion of the side-rail assembly 30 (e.g., the pair of side portions 30a, the front portion 30b, and/or the rear portion) may comprise an elongated side rail 32 and a plurality of uprights 34 extending down from the side rail 32. The side rails 32 may, in some embodiments, be formed from square, steel tubing. The uprights 34 may comprise steel angle bars, such as formed in an “L-shape,” as will be discussed in more detail below. Upper ends of the uprights 34 may be welded to the side rail 32. Alternatively, fasteners may be used to secure the uprights 34 to the side rails 32.

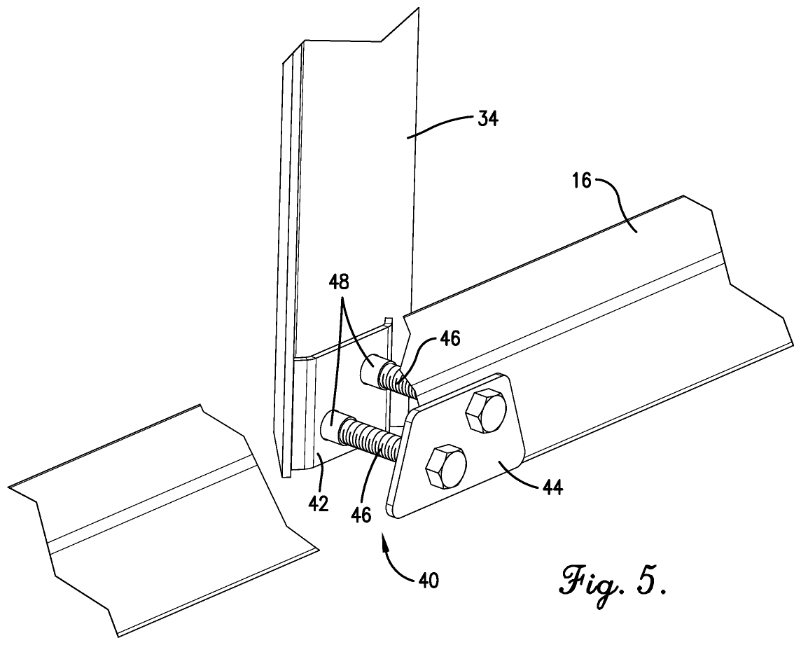

A connection assembly (labeled with reference numeral 40) may be used to secure the side-rail assembly 30 to the main section 14, as shown in more detail in FIGS. 5-8 and. In some embodiments, each of the uprights 34 of the side-rail assembly 30 may be associated with a connection assembly 40 that is configured to secure the associated upright 34 to the base frame 16 of the main section 14. The connection assemblies 40 may be formed from steel components and may each comprise an outer connection plate 42 configured to be rigidly mounted (e.g., via welding) to a bottom portion of a respective upright 34. When the side-rail assembly 30 is mounted to the base frame 16, the outer connection plates 42 will generally be positioned adjacent to an outer side or surface of the base frame 16. The connection assemblies 40 may each further comprise an inner connection plate 44, configured to be positioned adjacent to an inner side or surface of the base frame 16. In some embodiments, the inner connection plates 44 may be rigidly secured to the base frame 16 (e.g., via welding). Each of the outer and inner plates 42, 44 may be formed with one or more through holes for receiving one or more fasteners 46 (e.g., threaded bolts). For instance, each of the outer and inner plates 42, 44 may be formed with a pair of through holes for receiving a pair of fasteners 46.

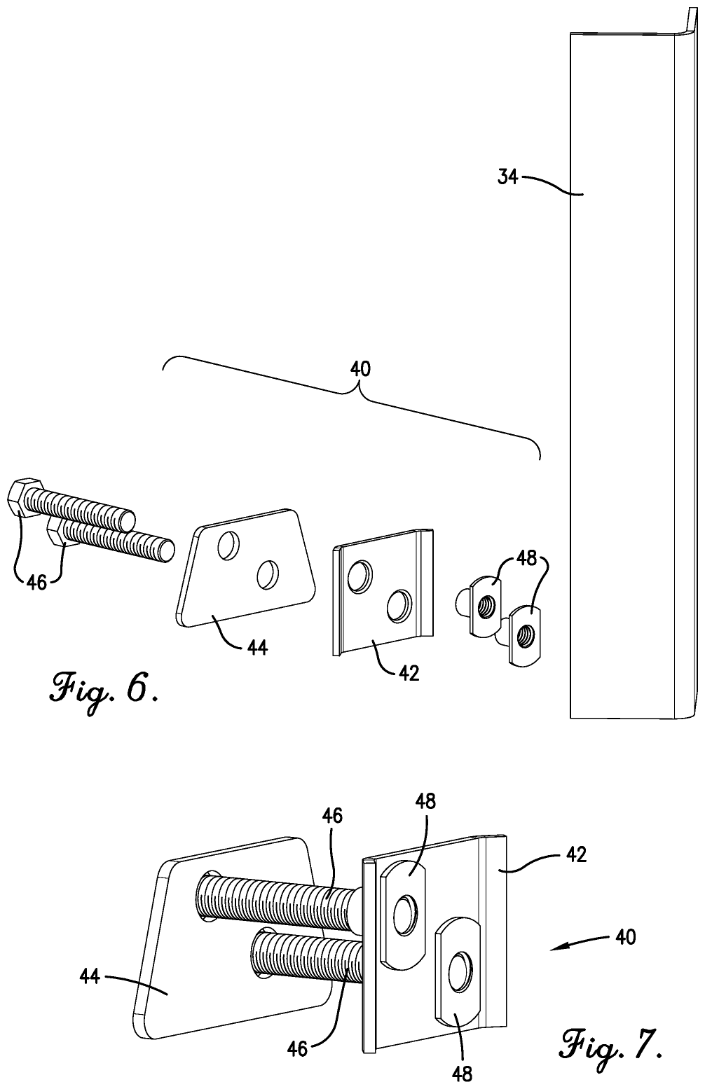

In some embodiments, the outer connection plates 42 of the connection assemblies 40 may include a weld nut 48 associated with each of the through holes of the outer connection plates 42, as perhaps best shown in FIGS. 6-8. The weld nuts 48 may be rigidly secured to the outer connection plates 42 (e.g., via welding). Specifically, the weld nuts 48 may each comprise a base portion that is welded to the exterior surface of the outer connection plate 42 and hollow projection portion with a threaded interior configured to threadedly receive the fasteners 46. When the base portions of the weld nuts 48 are welded to the outer connection plate 42, the projection portions will generally extend through the through holes of the outer connection plate 42, as shown in FIGS. 5 and 7.

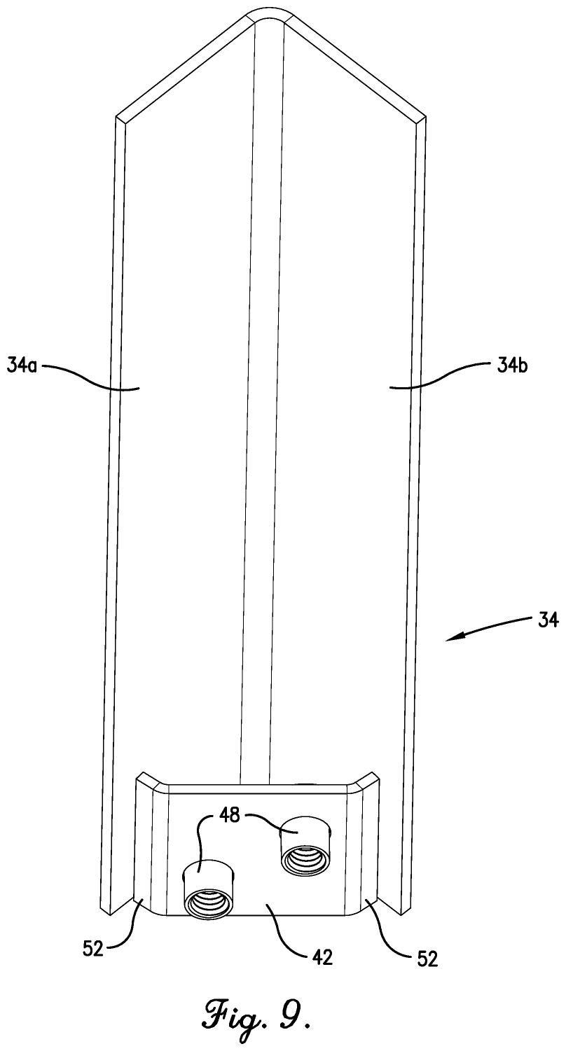

In view of the above, the connection assemblies 40 permit the side-rail assembly 30 to be secured to the base frame 16 of the main section 14 in an aesthetically pleasing and structurally-sound manner. In more detail, as perhaps best illustrated in FIG. 4, the components of the base frame 16 (e.g., the two side frame elements 16a and the front frame element 16b) may include a plurality of through hole pairs, with each through hole pair configured to be associated with an upright 34 of the side-rail assembly 30. As was noted previously, and as illustrated in FIG. 9, one of the outer connection plates 42 may be rigidly secured (e.g., via welding) to the bottom portion of one of the uprights 34. Weld nuts 48 may be secured the outer connection plate 42 (e.g., by welding the base portions to the outer connection plate 42), such that the projection portions of the weld nuts 48 extend through the through holes of the outer connection plate 42.

As such, when assembling the side-rail assembly 30 with the base frame 16, the bottom portion of each upright 34 can be aligned with the exterior side of the base frame 16 such that a through hole pair of the base frame 16 is aligned with the through holes (and/or the weld nuts 48) of the outer connection plate 42. Specifically, with the weld nuts 48 inserted through the through holes of the outer connection plate 42, the outer connection plate 42 (and the associated upright 34) can be properly aligned with the base frame 16 of the main section 14 by aligning the projection portions of the weld nuts 48 with the through hole pairs formed in the base frame 16. Such alignment will generally permit the projection portions of the weld nuts 48 to at least partially extend through the through holes formed in the base frame 16. As a result, with the weld nuts 48 engaged with associated through holes of the base frame 16, the side-rail assembly (and particularly the uprights 34) will be properly aligned with the base frame 16.

Correspondingly, the inner connection plates 44 may be aligned with the interior side of the base frame 16 such that a through hole pair of the base frame 16 is aligned with the through holes of each of the inner connection plates 44. It should be understood that in some embodiments, the inner connection plates 44 may be rigidly secured to the interior side of the base frame 16 (via welding). Thus, for each pair of through holes formed in the base frame 16, such through holes are aligned with the through holes of the inner and outer connection plates 42, 44 of one of the connection assemblies 40. Furthermore, because the weld nuts 48 are inserted within the through holes of the outer connection plate 42, the weld nuts 48 are also aligned with the through holes of the base frame 16 and of each of the inner and outer connection plates 42, 44.

As a result, and as perhaps best illustrated by FIG. 4, a pair of fasteners 46 can be inserted through each of the inner connection plates 44, through each of the through hole pairs of the base frame 16, and into engagement with each of the outer connection plate 42 (e.g., via the weld nuts 48 secured to the outer connection plates 42). Such a configuration will, thus, permit the side-rail assembly 30 to be properly aligned with the main section 14 and rigidly secured to the base frame 16 of the main section 14 by securing the uprights 34 of the side-rail assembly 30 to the frame elements 16a, b, c of the base frame 16.

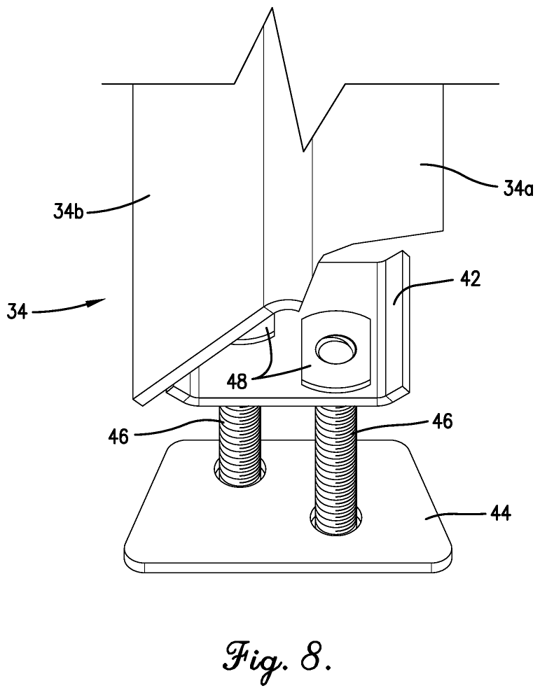

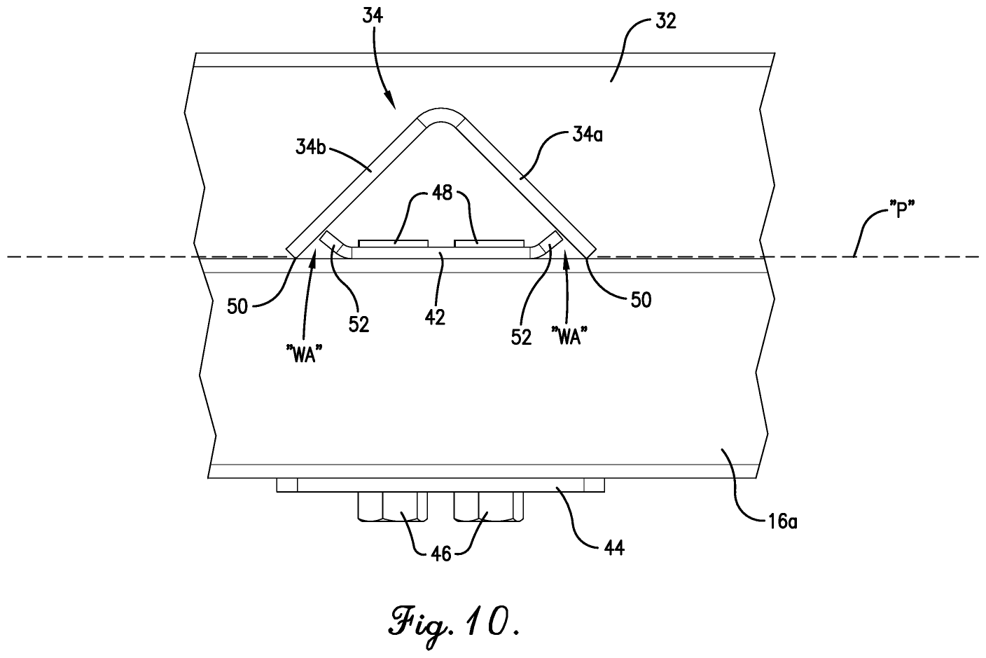

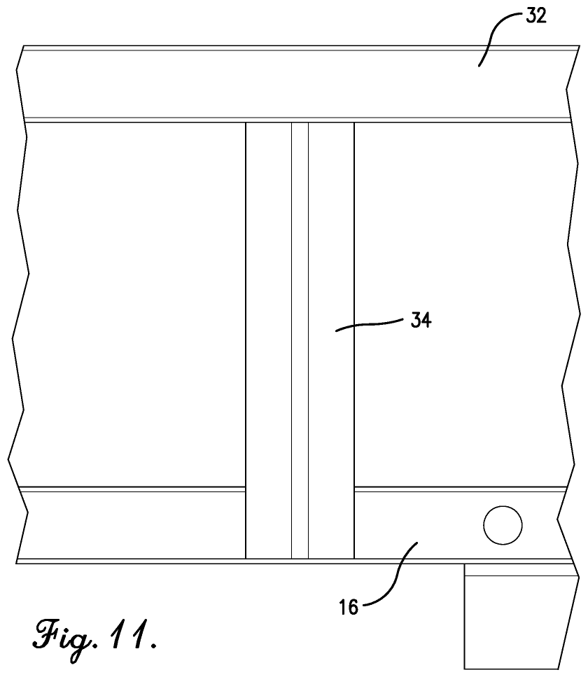

In some embodiments, as shown in FIGS. 8-10, the outer connection plate 42 of the connection assembly 40 may be rigidly secured to the bottom portion of the upright 34, such that the upright 34 can be flushly secured to the base frame 16. In more detail, and as was described previously, the uprights 34 may comprise angle bars formed in a “L-shape.” Specifically, each upright 34 may have a first side 34a and a second side 34b that extend away from each other at an interior angle of about 90°, so as to form the “L-shape.” The outer connection plate 42 may be secured within the interior of the upright 34 so as to extend between the first and second sides 34a, b of the upright 34. Beneficially, however, the outer connection plate 42 will be positioned within the interior angle area of the upright 34 such that the outer connection plate 42 does not extend beyond an imaginary plane “P” that is aligned with each distal end 50 of the first and second sides 34a, b of the upright 34 (see, e.g., FIG. 10). In some embodiments, an interior surface of a central portion the outer connection plate 42 (or at least a portion thereof) will be aligned with such imaginary plane “P.”

Remaining with FIG. 10, side edges 52 of the outer connection plate 42 may be angled away from the central portion of the outer connection plate 42. When the side-rail assembly 30 is assembled with the base frame 16 of the frame section 14, the side edges 52 may extend exteriorly (towards the first and second sides 34a, b of the upright 34) so as to present an open area (referred to as a weld area “WA”) between the side edges of the outer connection plate 42 and the base frame 16. Welding may be applied within the weld areas “WA” to secure the outer connection plate 42 to the upright 34. Beneficially, by having the side edges 52 of the outer connection 42 plate bent exteriorly, weld can be applied to the outer connection plate 42 and upright 34 without the weld extending beyond the distal ends 50 of the first and second sides 34a, b of the upright 34 (with such distal ends 50 shown in alignment with the imaginary plane “P”). As a result, the upright 34 can be flushly engaged with the base frame 16 and can be securely engaged in such a flush configuration with via fasteners 46 of the connection assembly 40.

In view of the above, embodiments of the present invention provide for the inventive trailer 10 to be shipped in a modular manner. Specifically, the trailer 10 will include modular components that can be arranged in a compact manner for efficient shipping. Furthermore, such components may be efficiently assembled after shipping to form an aesthetic, structurally-sound trailer. For example, according to embodiments of the present invention, the main section 14 of the trailer 10 may be shipped, e.g., within a semi-hauler, separately (i.e., in a disassembled form) from the side-rail assembly 30, the towbar 12, and/or the ramp 26. As such, a plurality of main sections 14 from a plurality of trailers 10 may be efficiently shipped together in a compact arrangement (e.g., stacked together) within a semi-hauler. Correspondingly, a plurality of side-rail assemblies 30 may be efficiently shipped together in a compact arrangement (e.g., stacked together) within a semi-hauler. Similarly, a plurality of towbars 12 and ramps 26 from the plurality of trailers may be efficiently shipped together in a compact arrangement (e.g., stacked together) within a semi-hauler. Once the semi hauler trailer reaches its intended destination, the components of the inventive trailer 10 can be assembled for use and/or for sale.

To assemble a given trailer 10, the towbar 12 may be secured to a front end of the main section 14 of the trailer 10, and the ramp 26 may be secured to the rear end of the main section 14 of the trailer 10. In addition, using the connection assemblies 40 described above, the side-rail assembly 30 of the trailer 10 may be connected to the base frame 16 of the main section 14 as described above. For example, one portion (e.g., side portions 30a or front portion 30b) of the side-rail assembly 30 may be secured to each of the side frame elements 16a of the base frame 16 and to the front frame element 16b of the base frame 16.

To secure the side-rail assembly 30 to the base frame 16, the connection assemblies 40 may be used. Specifically, as was described above, each upright 34 can include an outer connection plate 42 rigidly secured thereto (with weld nuts 48 secured to the outer connection plate 42 and protruding through the through holes of the outer connection plate 42). Similarly, a plurality of inner connection plates 44 can be rigidly secured to the base frame 16, each in alignment with a pair of through holes formed through the base frame 16. As such, each upright 34 can be properly aligned with the base frame 16 by aligning the projecting portions of the weld nuts 48 of the outer connection plate 42 with associated through hole pairs of the base frame 16 and an associated inner connection plate 44. Once aligned, the fasteners 46 can be inserted through the inner connection plates 44, through the base frame 16, and into engagement with the outer connection plate 42 via threaded engagement with the weld nuts 48.

Given the configuration of the outer connection plate 42 not extending past the distal ends 50 of the sides 34a, b of the upright 34, the side-rail assembly 30 can be flushly engaged with the base frame 16, as shown in FIG. 11, without the connection assemblies 40 (and particularly the outer connection plates 42) interfering with the mating of the uprights 34 with the base frame 16. As a result, the components of the connection assemblies 40 are hidden from view (i.e., not visible) when viewing the trailer 10 from the front and/or from the sides of the trailer 10.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A modular trailer comprising:
a base frame;
a side-rail assembly configured to be secured to said base frame, wherein said side-rail assembly comprises an elongated side rail and a plurality of uprights extending from said side rail; and
a plurality of connection assemblies configured to secure said side-rail assembly to said base frame, wherein each connection assembly comprises an outer connection plate rigidly secured to an associated upright of said plurality of uprights and one or more fasteners configured to extend through said base frame and into engagement with said outer connection plate.

2. The modular trailer of claim 1, wherein said base frame is generally rectangular and comprises a pair of side frame elements and a front frame element extending between said side frame elements.

3. The modular trailer of claim 2, wherein said side rail assembly comprises a pair of side portions and a front portion, and wherein said side portions are configured to be engaged with said side frame elements, and said front portion is configured to be engaged with said front frame element.

4. The modular trailer of claim 1, wherein each connection assembly includes an inner connection plate secured to an interior side of said base frame.

5. The modular trailer of claim 4, wherein said inner connection plate is welded to said base frame.

6. The modular trailer of claim 5, wherein said inner connection plate includes one or more through holes, wherein said base frame includes one or more through holes, and wherein for each connection assembly, said fasteners extend through the through holes of said inner connection plate and said base frame to engage with said outer connection plate.

7. The modular trailer of claim 1, wherein each outer connection plate includes one or more through holes and one or more weld nuts engaged with said through holes.

8. The modular trailer of claim 7, wherein the weld nuts of each connection assembly are welded to an associated outer connection plate.

9. The modular trailer of claim 7, wherein the weld nuts of each connection assembly are configured to engage with associated through holes of said base frame to properly align the uprights with the base frame.

10. The modular trailer of claim 1, wherein each of said uprights comprises an angle bar including a first side and a second side angled with respect to each other so as to form an L-shape, wherein for each connection assembly said outer connection plate extends between the first and second sides of the associated upright.

11. The modular trailer of claim 10, wherein side edges of said outer connection plate are respectively angled toward the first and second sides of said associated upright so as to present weld areas, and wherein said outer connection plate is welded to said associated upright by weld having been placed in the weld areas.

12. The modular trailer of claim 11, wherein neither said weld nor said outer connection plate extends past distal ends of said first and second sides of the associated upright.

13. The modular trailer of claim 1, wherein said uprights are flushly engaged with said base frame.

14. The modular trailer of claim 13, where said outer connection plates are not visible from lateral sides or from a front of said trailer.

15. A modular trailer comprising:
a base frame;
a side-rail assembly configured to be secured to said base frame, wherein said side-rail assembly comprises an elongated side rail and a plurality of uprights extending from said side rail; and
a connection assembly associated with each upright and configured to secure said side-rail assembly to said base frame, wherein when viewing said trailer from a lateral side, said connection assemblies are not visible.

16. A method of assembling a modular trailer, said method comprising the steps of:
(a) providing the modular trailer comprising a base frame and a side-rail assembly configured to be secured to the base frame, wherein the side-rail assembly comprises an elongated side rail and a plurality of uprights extending from the side rail; and
(b) coupling each upright to the base frame via a connection assembly, wherein each connection assembly comprises an outer connection plate rigidly secured to one of the uprights and one or more fasteners configured to extend through the base frame and into engagement with the outer connection plate,
wherein when viewing the modular trailer from a lateral side, the connection assemblies are not visible.

17. The method of claim 16, wherein each connection assembly includes an inner connection plate secured to an interior side of the base frame, wherein the inner connection plate includes one or more through holes, wherein the base frame includes one or more through holes, and wherein after said coupling of step (b), the fasteners of each connection assembly extend through the through holes of the inner connection plate and the base frame to engage with the outer connection plate.

18. The method of claim 16, wherein each outer connection plate includes one or more through holes and one or more weld nuts engaged with the through holes, and wherein after said coupling of step (b), the weld nuts of each connection assembly are engaged with associated through holes of the base frame to properly align the uprights with the base frame.

19. The method of claim 16, wherein each of the uprights comprises an angle bar including a first side and a second side angled with respect to each other so as to form an L-shape, wherein for each connection assembly the outer connection plate extends between the first and second sides of the associated upright.

20. The method of claim 19, wherein for each connection assembly, the outer connection plate does not extend past distal ends of the first and second sides of the associated upright.
